(19) United States
(12) Patent Application Publication
(10) Pub. No.: US 2006/0087123 A1
(43) Pub. Date: Apr. 27, 2006

(54) Dual-rotor, single input/output starter-generator

(76) Inventors: David E. Stout, Tucson, AZ (US); Michael W. Duddeck, Tucson, AZ (US); Wayne T. Pearson, Tucson, AZ (US); Mingzhou Xu, Tucson, AZ (US)

Correspondence Address: HONEYWELL INTERNATIONAL, INC.;Law Dept. AB2, P.O. Box 2245, Morristown, NJ, 07962-9806, US

(21) Appl. No.: 10/971,738

(22) Filed: Oct. 22, 2004

(51) Int. Cl. F01K 15/00; F01K 17/02; F02C 6/18; F02C 6/00; B60L 1/02

(52) U.S. Cl. 290/2

(57) ABSTRACT

A starter-generator includes redundant motor/generator sets disposed within a common housing. Each motor/generator set is electrically and mechanically independent of one another, with the exception of a common input/output gear. The starter-generator is configured such that if one of the motor/generator sets experiences a predetermined torsional load, it will decouple from the input/output gear, allowing the other motor/generator set to continue operation uninterrupted.

### TECHNICAL FIELD

The present invention relates to rotating electrical machines such as starter-generators for gas turbine engines and, more particularly, to a dual-rotor, single input/output starter-generator.

### BACKGROUND

An aircraft may include various types of rotating electrical machines such as, for example, generators, motors, and motor/generators. Motor/generators are used as starter-generators in some aircraft, since this type of rotating electrical machine may be operated in both a motor mode and a generator mode. A starter-generator may be used to start the engines or auxiliary power unit (APU) of an aircraft when operating as a motor, and to supply electrical power to the aircraft power distribution system when operating as a generator. Thus, when operating as a motor, a starter-generator may be designed to supply mechanical output torque sufficient to start the engines.

One particular type of aircraft starter-generator includes three separate brushless generators, namely, a permanent magnet generator (PMG), an exciter generator, and a main motor/generator. The PMG includes permanent magnets on its rotor. When the PMG rotor rotates, AC currents are induced in stator windings of the PMG. These AC currents are typically fed to a regulator or a control device, which in turn outputs either DC power or AC power, depending upon whether the starter-generator is being operated in a generator mode or a motor mode.

If the starter-generator is operating in the generator mode, the regulator or control device supplies DC power to stator windings of the exciter. As the exciter rotor rotates, three phases of AC current are typically induced in the exciter rotor windings. Rectifier circuits that rotate with the exciter rotor rectify this three-phase AC current, and the resulting DC currents are provided to the rotor windings of the main motor/generator. Finally, as the main motor/generator rotor rotates, three phases of AC current are typically induced in the main motor/generator stator, and this three-phase AC output can then be provided to a load.

If the starter-generator is operating in the motor mode, the regulator or control device supplies AC power to the exciter stator. This AC power induces, via a transformer effect, an electromagnetic field in the exciter armature, whether the exciter rotor is stationary or rotating. The AC currents produced by this induced field are rectified by the rectifier circuits and supplied to the main motor/generator rotor, which produces a DC field in the rotor. The regulator or control device also supplies variable frequency AC power to the main motor/generator stator. This AC power produces a rotating magnetic field in the main stator, which causes the main rotor to rotate and supply mechanical output power.

In order to prevent, or at least significantly reduce the likelihood of, the inoperability of a single starter-generator from adversely affecting the aircraft, many aircraft include two or more redundant starter-generators. These redundant starter-generators can increase overall system and aircraft weight and, if axially disposed on the same rotor, can increase overall system size and the overhung moment of the starter-generator, both of which may be undesirable in an aircraft environment.

Hence, there is a need for a redundant starter-generator system that does not significantly increase system and aircraft weight, and/or is shorter in length, and or has less overhung moment that current redundant starter-generator system designs. The present invention addresses one or more of these needs.

### BRIEF SUMMARY

The present invention provides a starter-generator that is much shorter in length, has a lower overhung moment, has improved rotor dynamics, and weighs significantly less than currently know dual starter generator designs

In one embodiment, and by way of example only, a dual-rotor, single input/output starter-generator includes a housing assembly, first and second motor/generators, first and second main rotor shaft gears, and an input/output gear. The first motor/generator is disposed within the housing assembly and includes a first main rotor shaft rotationally mounted within the housing assembly. The second motor/generator is disposed within the housing assembly and includes a second main rotor shaft rotationally mounted within the housing assembly. The first main rotor shaft gear is coupled to the first main rotor shaft. The second main rotor shaft gear coupled to the second main rotor shaft. The input/output gear is rotationally mounted on the housing assembly and is in engagement with the first and second main rotor shaft gears, whereby the input/output gear receives a drive force from, or supplies a drive force to, one or both of the first and second main rotor shaft gears.

In another exemplary embodiment, a dual-rotor, single drive shaft starter-generator includes a housing assembly, a first main rotor shaft, a first main rotor, a first main stator, a first main rotor shaft gear, a second main rotor shaft, a second main rotor, a second main stator, a second main rotor shaft gear, and an input/output gear. The first main rotor shaft is rotationally mounted within the housing assembly, the first main rotor is mounted on the first main rotor shaft, the first main stator surrounds at least a portion of the first main rotor, and the first main rotor shaft gear is coupled to the first main rotor shaft. The second main rotor shaft is rotationally mounted within the housing assembly, the second main rotor is mounted on the second main rotor shaft, the second main stator surrounds at least a portion of the second main rotor, and the second main rotor shaft gear is coupled to the second main rotor shaft. The input/output gear is rotationally mounted on the housing assembly and is in engagement with the first and second main rotor shaft gears, whereby the input/output gear receives a drive force from, or supplies a drive force to, one or both of the first and second main rotor shaft gears.

Other independent features and advantages of the preferred starter-generator will become apparent from the following detailed description, taken in conjunction with the accompanying drawings which illustrate, by way of example, the principles of the invention.

### BRIEF DESCRIPTION OF THE DRAWINGS

FIG. 1 is a functional schematic block diagram of an exemplary embodiment of a dual-rotor starter-generator according to the present invention;

FIGS. 2 and 3 are perspective views of an exemplary physical implementation of the starter-generator shown in FIG. 1; and

FIG. 4 is a perspective cut-away view of the starter-generator shown in FIGS. 2 and 3, with a portion thereof being shown in cross section.

### DETAILED DESCRIPTION OF A PREFERRED EMBODIMENT

The following detailed description is merely exemplary in nature and is not intended to limit the invention or the application and uses of the invention. Furthermore, there is no intention to be bound by any theory presented in the preceding background or the following detailed description. In this regard, it is to be appreciated that the present invention is not limited to use in conjunction with a specific type of electrical machine. Thus, although the present invention is, for convenience of explanation, depicted and described as being implemented in a brushless AC (alternating current) machine, it will be appreciated that it can be implemented in other AC machine designs needed in specific applications.

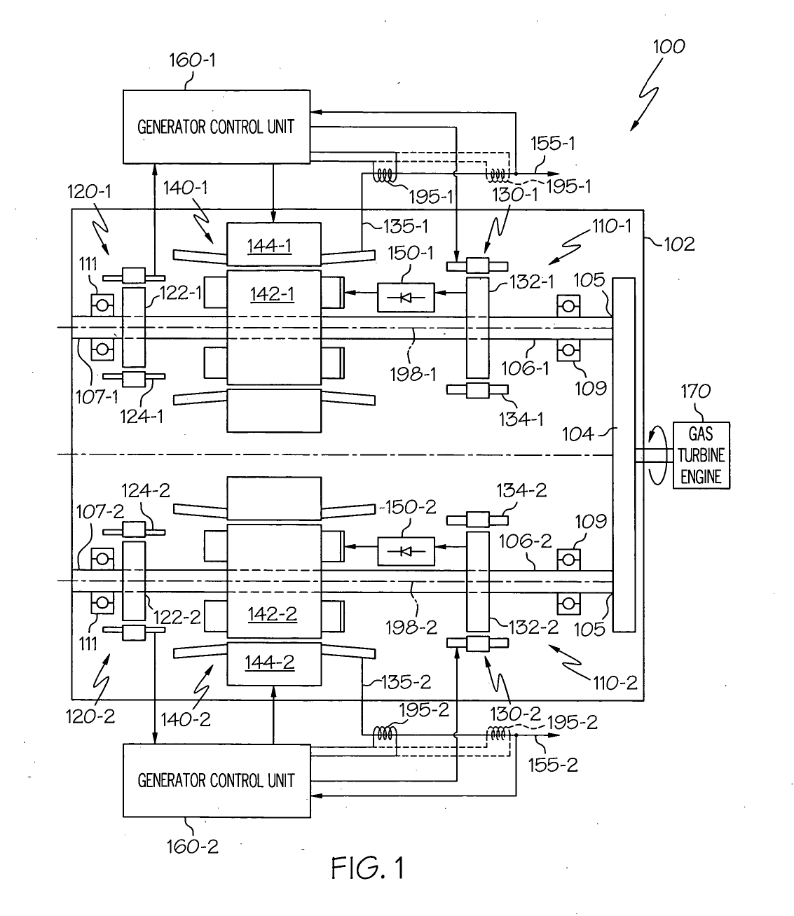

Turning now to the description, and with reference first to FIG. 1, a functional schematic block diagram of an exemplary embodiment of a dual-rotor starter-generator 100 is shown. The depicted exemplary starter-generator 100 includes two motor/generator sets 110-1, 110-2 disposed within a single housing assembly 102, and operably coupled to one another via an input/output gear set 104. In the depicted embodiment, each motor/generator set is a brushless, synchronous, wound, salient-pole AC machine, and each includes a permanent magnet generator (PMG) 120-1, 120-2, an exciter 130-1, 130-2, a main motor/generator 140-1, 140-2, and one or more rectifier assemblies 150-1, 150-2. It is noted that the starter-generator 100 may be operable at various speeds, for a gas turbine engine in aircraft, space, marine, land, or other vehicle-related applications where gas turbine engines are used. For aircraft applications, gas turbine engines are used for propulsion (e.g., the aircraft's main engines) and/or for power (e.g., the auxiliary power unit (APU)).

The PMG 120, the exciter 130, and the main motor/generator 140 each include a rotor and a stator. More particularly, each PMG 120-1, 120-2 includes a PMG rotor 122-1, 122-2 and a PMG stator 124-1, 124-2, each exciter 130-1, 130-2 includes an exciter rotor 132-1, 132-2 and an exciter stator 134-1, 134-2, and each main motor/generator 140-1, 140-2 includes a main motor/generator rotor 142-1, 142-2 and a main motor/generator stator 144-1, 144-2. The PMG rotors 122-1, 122-2, the exciter rotors 132-1, 132-2, and the main motor/generator rotors 142-1, 142-2 are each mounted on a shaft 106-1, 106-2. Each shaft 106-1, 106-2 includes two ends—a drive end 105, which is configured to receive or supply a rotational drive force, and an anti-drive end 107, which is not so configured.

The shafts 106-1, 106-2 are each rotationally mounted in the housing assembly 102 via a plurality of bearing assemblies. In the depicted embodiment, two bearing assemblies, a drive-end bearing assembly 109 and an anti-drive end bearing assembly 111, are used. The PMG rotors 122-1, 122-2, the exciter rotors 132-1, 132-2, and the main motor/generator rotors 142-1, 142-2 in each associated motor/generator set 110-1, 110-2 are preferably configured to all rotate along the same axis 198-1, 198-2, and at the same rotational speed. However, it will be appreciated that in other embodiments one or more of the PMG rotors 122-1, 122-2, the exciter rotors 132-1, 132-2, and the main motor/generator rotors 142-1, 142-2 may rotate along a different axis. Moreover, the relative positioning of the PMGs 120-1, 120-2, the exciters 130-1, 130-2, and the main motor/generators 140-1, 140-2 can be modified in different embodiments. Indeed, as will be described below, in a preferred physical implementation of the starter-generator 100, the PMGs 120-1, 120-2, and the exciters 130-1, 130-2 are physically located on the same side of the main motor/generators 140-1, 140-2.

No matter the relative physical positioning of each of the components within the starter-generator housing assembly 102, it will be appreciated that the starter-generator 100 is configured to operate in one of two modes, a generator mode and a motor mode. When the starter-generator 100 is configured to operate in the generator mode, the input/output gear set 104 receives a rotational drive force from a prime mover 170, and when the starter-generator 100 is configured to operate in the motor mode, the input/output gear set 104 supplies the rotational drive force to the prime mover 170. The prime mover 170 may be any one of numerous types of machines capable of supplying and receiving sufficient rotational torque to and from the input/output gear set 104. However, in the depicted embodiment, the prime mover 170 is an aircraft gas turbine engine.

No matter the specific type of prime mover 170 that is used, the rotational drive force it supplies is transferred, via the input/output gear set 104 to the shafts 106-1, 106-2. This in turn causes the PMG rotors 122-1, 122-2, the exciter rotors 132-1, 132-2, and the main motor/generator rotors 142-1, 142-2 to all rotate. As the PMG rotors 122-1, 122-2 rotate, each generates AC power in its respective PMG stator 124-1, 124-2, which is in turn supplied to a respective motor/generator control unit 160-1, 160-2. The motor/generator control units 160-1, 160-2 receive the AC current from the respective PMG stators 124-1, 124-2, and supply regulated direct current (DC) power to its associated exciter stator 134-1, 134-2. The exciter rotors 132-1, 132-2 in turn supply AC power to the respective rectifier assemblies 150-1, 150-2. The output from each rectifier assembly 150-1, 150-2 is DC power, which is supplied to its respective main motor/generator rotor 142-1, 142-2. As the main motor/generator rotors 142-1, 142-2 rotate, AC power is generated in its respective main motor/generator stator 144-1, 144-2.

During its operation in the generator mode, the starter-generator 100 is capable of supplying output power at a variety of frequencies. The AC power generated in the main motor/generator stators 144-1, 144-2 is typically three-phase AC power. In each motor/generator set 110-1, 110-2, one or more stator output leads 135-1, 135-2 supplies the generated AC power to external systems and equipment via one or more terminal assemblies 155-1, 155-2. The motor/generator control units 160-1, 160-2 regulate the power output from the respective motor/generator sets 110-1, 110-2 based upon monitoring signals provided to it from one or more monitoring devices 195-1, 195-2.

When the starter-generator 100 is operating in the motor mode, the motor/generator control units 160-1, 160-2 each supply fixed-frequency AC power to the respective exciter stators 134-1, 134-2, and variable-frequency AC power to the respective main motor/generator stators 144-1, 144-2. The exciter rotors 132-1, 132-2 in turn supply AC power to the respective rectifier assemblies 150-1, 150-2, which rectify the AC power and supply DC power to the respective main motor/generator rotors 142-1, 142-2. As a result, the main motor/generator rotors 142-1, 142-2 are rotated, supplying rotational power to the gas turbine engine 170, via the input/output gear set 104.

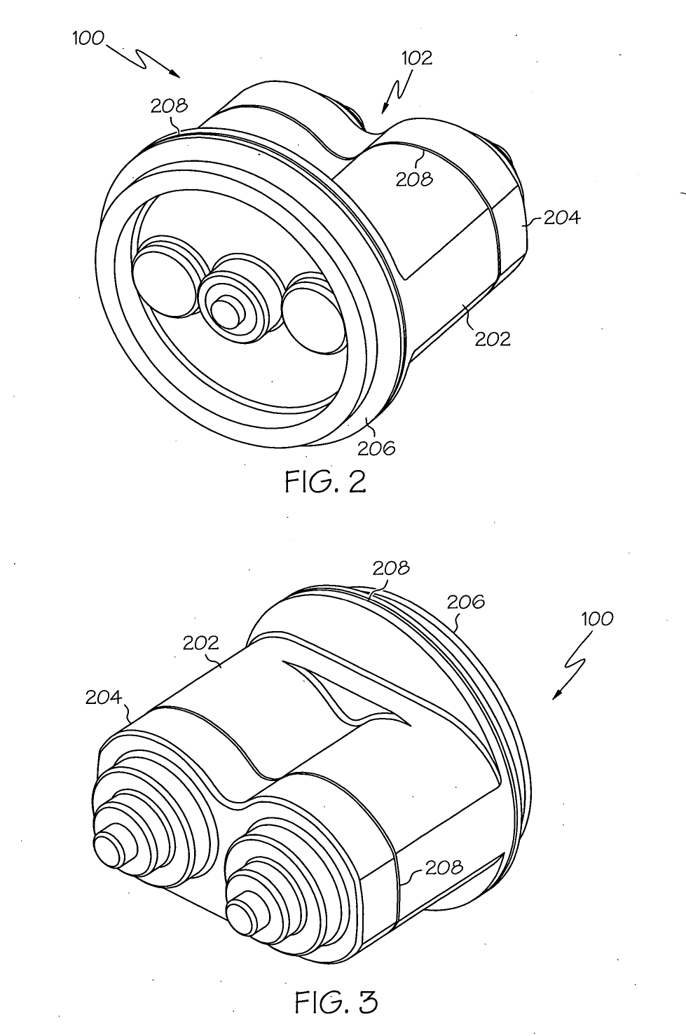

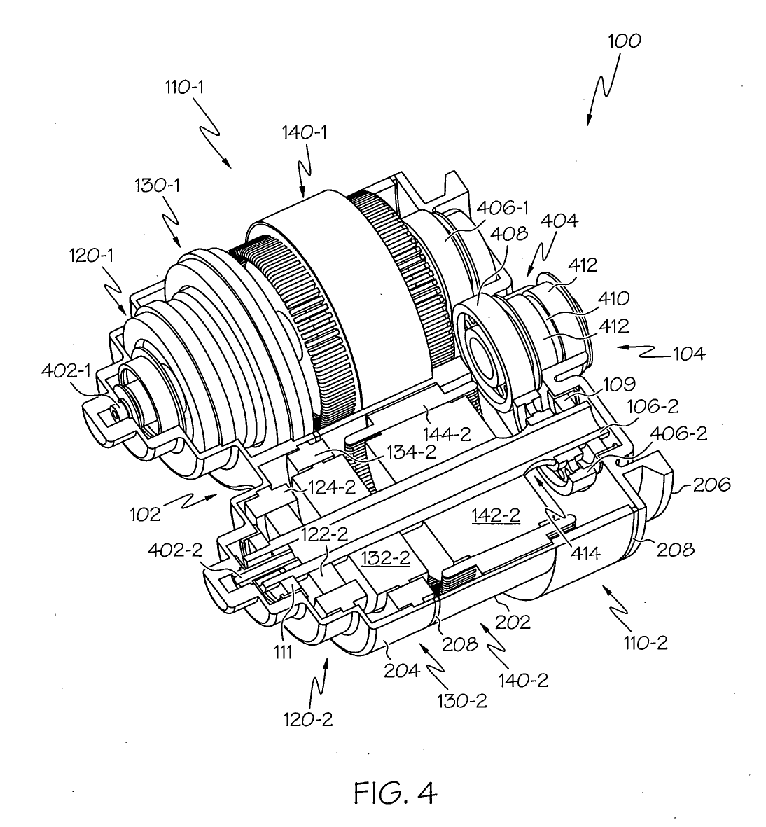

Turning now to FIGS. 2-4, a particular physical implementation of the starter-generator 100 described above is illustrated in more detail and will now be described. In doing so, it should be appreciated that like reference numerals in FIGS. 1-4 refer to like parts. In any case, it is seen that the housing assembly 102, at least in the depicted embodiment, includes three sections, a main housing 202, an end bell 204, and an input/output housing 206. The main housing 202 is coupled to both the end bell 204 and the input/output housing 206, via intervening seal plates 208. As is shown most clearly in FIG. 4, the main housing 202 houses the main motor/generators 110-1, 110-2 and various portions of the input/output gear set 104, the end bell 204 houses the PMGs 120-1, 120-2 and the exciters 130-1, 130-2, and the input/output housing 206 also houses various portion of the input/output gear set 104.

With continued reference to FIG. 4, it is seen that each shaft 106-1, 106-2 extends through the main housing 202, and into both the end bell 204 and the input/output housing 206. The drive end-bearing assemblies 109 are each mounted in the input/output housing 206, and the drive-end bearing assemblies 111 are each mounted in the end bell 204. Together, as was mentioned above, these bearing assemblies 109, 111 rotationally mount the shafts 106-1, 106-2 in the housing assembly 102. Thus, upon receipt of the rotational drive force from the gas turbine engine 170 (not shown in FIGS. 2-4) or one or both of the shafts 106-1, 106-2, the input/output gear set 104, an embodiment of which will be described in more detail further below, will deliver the rotational drive force to, or supply the rotational drive force from, the shafts 106-1, 106-2 or the gas turbine engine 170, respectively.

The bearing assemblies 109, 111 are lubricated using a lubricant, such as oil, that is supplied to the starter-generator 100 from a non-illustrated lubricant source. In addition, the lubricant is also preferably used as a cooling fluid for various other portions of the motor/generator sets 110-1, 110-2 including, for example, the PMGs 120-1, 120-2, the exciters 130-1, 130-2, the main motor/generators 140-1, 140-2, and the rectifier assemblies 150-1, 150-2. In the depicted embodiment, the lubricant is supplied to each motor/generator set 110-1, 110-2 from an external source. It enters through an oil inlet port and circulates in grooves cooling the back iron of the main motor/generator stator 144-1, 144-2. The oil is then directed via internal porting and channels to a transfer tube 402-1, 402-2, respectively, mounted in the end bell 204. The transfer tubes 402-1, 402-2 each extend at least partially into the associated shaft 106-1, 106-2. As is shown in FIG. 4, each shaft 106-1, 106-2 (only one shown in cross section) is substantially hollow. Thus, lubricant supplied to the transfer tubes 402-1, 402-2 flows into the associated shafts 106-1, 106-2. The lubricant within the shafts 106-1, 106-2 is distributed, via non-illustrated spray orifices that extend through the shafts 106-1, 106-2, to the bearing assemblies 109, 111 and other motor/generator set components. The heated oil falls to the generator/motor sump from which it can be scavenged or drained from the unit and returned to the external cooling circuit.

The input/output gear set 104 may be implemented using any one of numerous types of gears in any one of numerous configurations. However, as shown in FIG. 4, in the depicted embodiment the input/output gear set 104 is implemented using three spur gears—a main input/output gear 404, and two shaft-mounted gears 406-1, 406-2. The main input/output gear 404 and the shaft-mounted gears 406-1, 406-2 are preferably identical in diameter, and thus rotate at substantially identical speeds. Thus, during normal operations of the starter-generator 100, the configurations of the motor/generator sets 110-1, 110-2 are such that each will also rotate at substantially identical speeds in both the motor mode and the generator mode.

The main input/output gear 404 includes a gear head 408 that is coupled to an input/output shaft 410. The input/output shaft 410 is rotationally mounted in the housing assembly 102 via a plurality of bearing assemblies 412, which are each mounted in the input/output housing 206. The input/output shaft 410 is adapted to couple to the gas turbine engine 170 and thus transfer the rotational drive force to or from the starter-generator 100, depending on whether the starter-generator 100 is configured to operate in the motor mode or the generator mode.

The gear head 408 engages both of the shaft-mounted gears 406-1, 406-2 and transfers the rotational drive force thereto, or receives the rotational drive force therefrom. The shaft mounted gears 406-1, 406-2, which are each mounted on one of the shafts 106-1, 106-2, in turn respectively transfers the rotational drive force to, or receives the rotational drive force from, its associated shaft 106-1, 106-2.

The starter-generator 100 is configured such that each of the motor/generator sets 110-1, 110-2 is electrically independent of one another, thereby reducing the likelihood of an electrical common-mode failure. In addition, each motor generator set 110-1, 110-2 is configured mechanically independent of one another, with the exception of the shared the main input/output gear 404. Because the main input/output gear 404 is shared, the starter-generator 100 could be subject to a postulated common-mode mechanical failure. For example, if one of the motor/generator sets 110-1 (110-2) were to become inoperable, or otherwise prevented or inhibited from rotating properly, the other motor/generator set 110-2 (110-1) could also be prevented or inhibited from rotating properly.

To address the postulated common-mode failure situation noted above, the motor/generator sets 110-1, 110-2 are each configured to selectively and independently prevent the drive force from being supplied by, or being received from, the gas turbine engine 170. In the depicted embodiment, this is accomplished by configuring each motor/generator set 110-1, 110-2 to selectively and independently decouple from the main input/output gear 404. More specifically, each of the shafts 106-1, 106-2 is configured to shear upon a predetermined torque magnitude being applied thereto. As shown in FIG. 4, this functionality is implemented by providing a reduced diameter shaft section 414 (only one shown in FIG. 4) on each of the shafts 106-1, 106-2. It will be appreciated that this is merely exemplary of one of numerous ways in which the motor/generator sets 110-1, 110-2 could be configured to selectively and independently decouple from the main input/output gear 404. For example, the shaft mounted gears 406-1, 406-2 could be configured to selectively disengage from the main input/output gear 404 upon the predetermined torque magnitude be reached.

The starter-generator 100 described herein provides an electromechanical machine that is much shorter in length, has a lower overhung moment, has improved rotor dynamics, and weighs significantly less than currently know dual starter-generator designs. The starter-generator 100 is also implemented with electrically and mechanically independent motor/generator sets 110-1, 110-2, thereby reducing the likelihood of common-mode failures.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A dual-rotor, single input/output starter-generator, comprising:
a housing assembly;
a first motor/generator disposed within the housing assembly, the first motor/generator including at least a first main rotor shaft rotationally mounted within the housing assembly;
a second motor/generator disposed within the housing assembly, the second motor/generator including at least a second main rotor shaft rotationally mounted within the housing assembly;
a first main rotor shaft gear coupled to the first main rotor shaft;
a second main rotor shaft gear coupled to the second main rotor shaft; and
an input/output gear rotationally mounted on the housing assembly and in engagement with the first and second main rotor shaft gears, whereby the input/output gear receives a drive force from, or supplies a drive force to, one or both of the first and second main rotor shaft gears.

2. The starter-generator of claim 1, further comprising:
a first main rotor mounted on the first main rotor shaft; and
a second main rotor mounted on the second main rotor shaft.

3. The starter-generator of claim 2, further comprising:
a first main stator surrounding at least a portion of the first main rotor; and
a second main stator surrounding at least a portion of the second main rotor.

4. The starter-generator of claim 1, further comprising:
a first permanent magnet generator (PMG) rotor mounted on the first main rotor shaft and configured to rotate therewith;
a first PMG stator surrounding at least a portion of the first PMG rotor;
a PMG rotor mounted on the second main rotor shaft and configured to rotate therewith; and
a second PMG stator surrounding at least a portion of the second PMG rotor.

5. The starter-generator of claim 1, further comprising:
a first exciter rotor mounted on the first main rotor shaft and configured to rotate therewith;
a first exciter stator surrounding at least a portion of the first exciter rotor;
an exciter rotor mounted on the second main rotor shaft and configured to rotate therewith; and
a second exciter stator surrounding at least a portion of the second exciter rotor.

6. The starter-generator of claim 1, wherein the first and second main rotor shafts are each substantially hollow, and wherein the starter-generator further comprises:
a first oil transfer conduit coupled to the housing assembly and having an inlet end adapted to receive oil from a pressurized oil source and an outlet end extending into the first main rotor shaft; and
a second oil transfer conduit coupled to the housing assembly and having an inlet end adapted to receive oil from a pressurized oil source and an outlet end extending into the second main rotor shaft.

7. The starter-generator of claim 1, wherein the first and second motor/generators are each configured to selectively and independently prevent supply of the drive force to, or receipt of the drive force from, the input/output gear.

8. The starter-generator of claim 7, wherein the first and second main rotor shafts are each configured to independently shear upon a predetermined torque magnitude being applied thereto, to thereby selectively and independently prevent the supply of the drive force to, or the receipt of the drive force from, the input/output gear.

9. The starter-generator of claim 1, wherein the first and second main rotor shaft gears are each configured to independently disengage from the input/output gear upon a predetermined torque magnitude being applied to the first and second main rotor shafts, respectively, to thereby selectively and independently prevent the supply of the drive force to, or the receipt of the drive force from, the input/output gear.

10. The starter-generator of claim 1, wherein the first and second main rotor shafts each have at least a drive end and an anti-drive end, and wherein the starter-generator further comprises:
a first drive end bearing assembly surrounding the first main rotor shaft and disposed proximate the first main rotor shaft drive end;
a first anti-drive end bearing assembly surrounding the first main rotor shaft and disposed proximate the first main rotor shaft anti-drive end;
a second drive end bearing assembly surrounding the second main rotor shaft and disposed proximate the second main rotor shaft drive end;
a second anti-drive end bearing assembly surrounding the second main rotor shaft and disposed proximate the second main rotor shaft anti-drive end.

11. A dual-rotor, single drive shaft starter-generator, comprising:
a housing assembly;
a first main rotor shaft rotationally mounted within the housing assembly;
a first main rotor mounted on the first main rotor shaft;
a first main stator surrounding at least a portion of the first main rotor;
a first main rotor shaft gear coupled to the first main rotor shaft;
a second main rotor shaft rotationally mounted within the housing assembly;
a second main rotor mounted on the second main rotor shaft;
a second main stator surrounding at least a portion of the second main rotor;
a second main rotor shaft gear coupled to the second main rotor shaft; and
an input/output gear rotationally mounted on the housing assembly and in engagement with the first and second main rotor shaft gears, whereby the input/output gear receives a drive force from, or supplies a drive force to, one or both of the first and second main rotor shaft gears.

12. The starter-generator of claim 11, further comprising:
a first permanent magnet generator (PMG) rotor mounted on the first main rotor shaft and configured to rotate therewith;
a first PMG stator surrounding at least a portion of the first PMG rotor;
a PMG rotor mounted on the second main rotor shaft and configured to rotate therewith; and
a second PMG stator surrounding at least a portion of the second PMG rotor.

13. The starter-generator of claim 11, further comprising:
a first exciter rotor mounted on the first main rotor shaft and configured to rotate therewith;
a first exciter stator surrounding at least a portion of the first exciter rotor;
a exciter rotor mounted on the second main rotor shaft and configured to rotate therewith; and
a second exciter stator surrounding at least a portion of the second exciter rotor.

14. The starter-generator of claim 11, wherein the first and second main rotor shafts are each substantially hollow, and wherein the starter-generator further comprises:
a first oil transfer conduits coupled to the housing assembly and having an inlet end adapted to receive oil from a pressurized oil source and an outlet end extending into the first main rotor shaft; and
a second oil transfer conduits coupled to the housing assembly and having an inlet end adapted to receive oil from a pressurized oil source and an outlet end extending into the second main rotor shaft.

15. The starter-generator of claim 11, wherein the first and second motor/generators are each configured to selectively and independently prevent supply of the drive force to, or receipt of the drive force from, the input/output gear.

16. The starter-generator of claim 15, wherein the first and second main rotor shafts are each configured to independently shear upon a predetermined torque magnitude being applied thereto, to thereby selectively and independently prevent the supply of the drive force to, or the receipt of the drive force from, the input/output gear.

17. The starter-generator of claim 15, wherein the first and second main rotor shaft gears are each configured to independently disengage from the input/output gear upon a predetermined torque magnitude being applied to the first and second main rotor shafts, respectively, to thereby selectively and independently prevent the supply of the drive force to, or the receipt of the drive force from, the input/output gear.

18. The starter-generator of claim 11, wherein the first and second main rotor shafts each have at least a drive end and an anti-drive end, and wherein the starter-generator further comprises:
a first drive end bearing assembly surrounding the first main rotor shaft and disposed proximate the first main rotor shaft drive end;
a first anti-drive end bearing assembly surrounding the first main rotor shaft and disposed proximate the first main rotor shaft anti-drive end;
a second drive end bearing assembly surrounding the second main rotor shaft and disposed proximate the second main rotor shaft drive end;
a second anti-drive end bearing assembly surrounding the second main rotor shaft and disposed proximate the second main rotor shaft anti-drive end.

19. A dual-rotor, single drive shaft starter-generator, comprising:
a housing assembly;
a first motor/generator disposed within the housing assembly, the first motor/generator including at least a first main rotor shaft rotationally mounted within the housing assembly;
a second motor/generator disposed within the housing assembly, the second motor/generator including at least a second main rotor shaft rotationally mounted within the housing assembly;
a first main rotor shaft gear coupled to the first main rotor shaft;
a second main rotor shaft gear coupled to the second main rotor shaft; and
an input/output gear rotationally mounted on the housing assembly and in engagement with the first and second main rotor shaft gears, whereby the input/output gear selectively receives a drive force from, or supplies a drive force to, one or both of the first and second main rotor shaft gears,
wherein the first and second motor/generators are each configured to selectively and independently prevent supply of the drive force to, or receipt of the drive force from, the input/output gear.

20. The starter-generator of claim 19, wherein the first and second main rotor shafts are each configured to independently shear upon a predetermined torque magnitude being applied thereto, to thereby selectively and independently prevent the supply of the drive force to, or the receipt of the drive force from, the input/output gear.

21. The system of claim 19, wherein the first and second main rotor shaft gears are each configured to independently disengage from the input/output gear upon a predetermined torque magnitude being applied to the first and second main rotor shafts, respectively, to thereby selectively and independently prevent the supply of the drive force to, or the receipt of the drive force from, the input/output gear.
